(19) United States
(12) Patent Application Publication
(10) Pub. No.: US 2006/0096110 A1
(43) Pub. Date: May 11, 2006

(54) Tool for writing straight lines

(76) Inventor: Sandra K. Clack, Jackson, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/272,273

(22) Filed: Nov. 10, 2005

Related U.S. Application Data
(60) Provisional application No. 60/626,855, filed on Nov. 10, 2004.

(51) Int. Cl. B43L 7/00

(52) U.S. Cl. 33/566

(57) ABSTRACT

A writing tool is provided that includes a rigid frame having a first side and an opposing second side and at least one rigid member therebetween. The first side and the opposing side are spaced apart so as to define an open space therebetween. The first side and the opposing second side further include a plurality of holes therein. The at least one flexible strand is secured to the first side and the second side through the plurality of holes in each of the first and second sides. The flexible strand is configured as a guideline that extends across the open space.

### CROSS-REFERENCE TO RELATED APPLICATIONS

This application claims the benefit of U.S. Provisional Application Ser. No. 60/626,855 filed Nov. 10, 2004, which is hereby incorporated by reference in its entirety.

### BACKGROUND

Whether journaling in a scrapbook or writing thank you notes, generating straight lines on an unlined surface is challenging. One method commonly used to write a straight line on unlined paper is to create a penciled-in guideline using a ruler or other straight edge, which is then carefully erased after the line is written. Unfortunately, in order to effectively erase the guidelines without erasing the written line, a writer is limited to using an ink pen or other non-erasable writing utensil. In addition, it is often not possible to remove all traces of the guideline, which diminishes the aesthetic value of the final written product.

Another method used to write straight lines is to use a ruler as a guideline. In this way, there are no guidelines to erase, however, because the ruler has a rigid straight edge, letters like g's, j's, p's, and y's are written without tails. Further, when writing a passage with more than one line, the ruler needs to be continually moved in order to write the next line.

The embodiments described hereinafter were developed in light of these and other drawbacks associated writing straight lines on unlined paper.

### BRIEF DESCRIPTION OF THE DRAWINGS

FIG. 1 illustrates a top view of an exemplary writing tool according to an embodiment; and

FIG. 2 illustrates a side view of an exemplary writing tool according to FIG. 1.

### DETAILED DESCRIPTION OF THE INVENTION

A tool for writing straight lines is provided. The tool includes a frame with a centrally disposed opening therein. Flexible strands are secured to opposing sides of the frame and serve as guidelines for writing in the opening. The flexible strands are secured through holes that are connected by channels in the opposing sides of the frame.

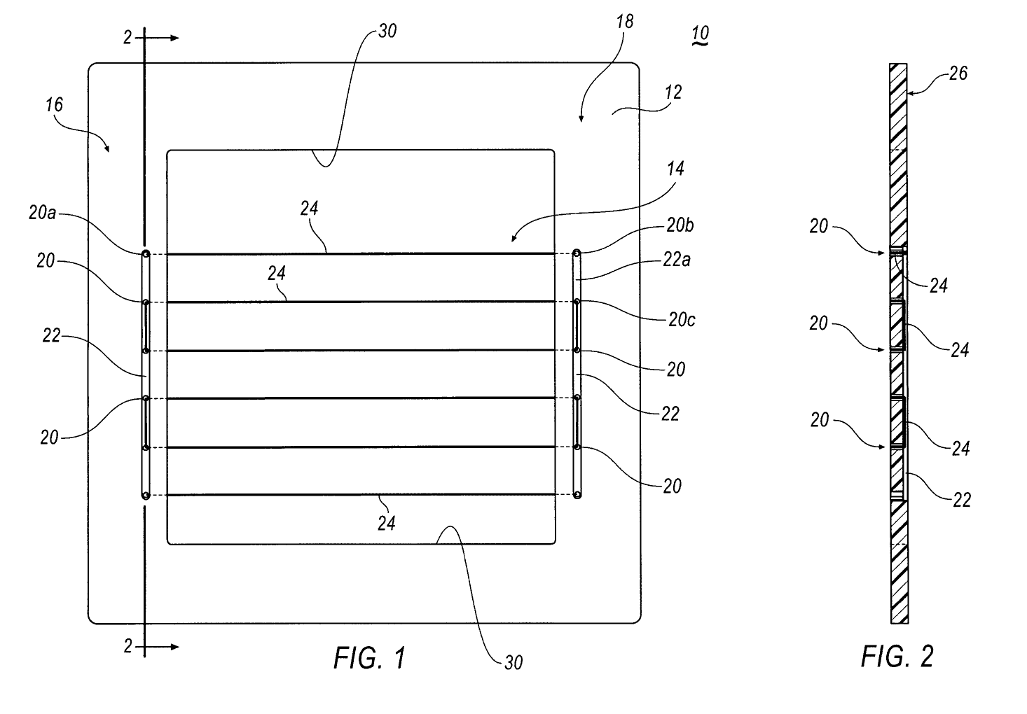

FIG. 1 shows an exemplary tool 10 for writing straight lines on unlined paper. Tool 10 includes a planar rigid frame 12 that outlines an opening 14. The frame 12 is generally constructed from plastic; however, other materials such as wood or metal are also suitable. The material used to construct the frame 12 can be transparent, opaque, or colored. In addition, the frame 12 may include embedded or affixed designs and decorations (not shown). By way of example, one or more sides of the frame 12 may include indicia representing a ruler or other measuring tool. Further, although the frame 12 in FIG. 1 illustrates a substantially square tool, one of ordinary skill in the art understands that frame 12 can be constructed to accommodate dimensions of any length and width.

Adjacent to the opening 14 along opposing sides 16, 18 of the frame 12, are a plurality of equidistant holes 20 connected by a recessed channel 22. Flexible guidelines are created across the opening 14 by securing flexible strands 24 to the plurality of holes 20 on both sides 16, 18 of the frame 12.

In one embodiment, the flexible guidelines are created by threading a unitary flexible strand 24 through the holes 20 and channels 22 on alternating sides of the frame 12. For example, as illustrated in FIGS. 1 and 2, one end of a unitary flexible strand 24 is secured to a first hole 20a on one side 16 of the frame 12 and extended across the opening 14 to a second hole 20b on the other side 18 of the frame 12. From the second hole 20b, the strand 24 is thread to an adjacent third hole 20c through a connecting channel 22a. By threading the flexible strand 24 through the channel 22a, the strand 24 remains flush, or slightly below, a top surface 26 of the frame 12 (shown in FIG. 2). The strand 24 is subsequently and continually thread across the opening 14 in the above referenced manner until a desired number of guidelines are created.

In another embodiment, the flexible guidelines are created with separate flexible strands 24 that are individually terminated in the holes 20 on opposing sides 16,18 of the opening 14.

One of ordinary skill in the art understands that any number of flexible guidelines can be used. In addition, the spacing between the guidelines can be adjusted depending on the application and the design criteria of a particular tool 10. Further, the overall spacing of the flexible guidelines with respect to peripheral edges 28, 30 of the opening 14 can vary depending on the application and design criteria of a particular tool 10. For example, in a scrapbooking application the distance between the first flexible guideline and the top edge 28 of the opening 14 may be greater than the distance between subsequent adjacent guidelines to accommodate larger titles or other design elements.

To use the writing tool 10, position the opening 14 over a desired region on a piece of paper (not shown) and write within the opening 14 using the flexible strands 24 as a guideline. The flexible strands 24 provide adequate support for writing straight lines, yet provide flexibility when writing letters with tails such as g's, j's, p's, and y's. As the writing utensil (e.g., pen, pencil, marker, etc.) moves downward to make the tail of these letters, the flexible strand 24 moves downward along with the utensil allowing movement below the guideline. After the tail of the letter is made, the flexible strand 24 resiliently springs back into place as the utensil moves back upward.

The tool 10 described above can be used on any paper or other writable surface. In fact, in addition to common uses such as scrapbooking, writing thank you notes, or other journaling, writing tool 10 can be used for any writing application such as, but not limited to, penmanship practice, placing graphics on textiles, and cake decorating.

While the present invention has been particularly shown and described with reference to the foregoing preferred embodiment, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and system within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiment is illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1 A writing tool comprising:
a rigid frame having a first side and an opposing second side and at least one rigid member therebetween, wherein said first side and said opposing side are spaced apart so as to define an open space therebetween;
a plurality of holes in each of said first and said second sides; and
at least one flexible strand secured to said first and said second side through said plurality of holes in each of said first and said second sides;
wherein said at least one flexible strand is configured as a guideline that extends across said open space.

2. The writing tool of claim 1, wherein said at least one flexible strand is thread through said plurality of holes in each of said first and said second sides.

3. The writing tool of claim 1, wherein said at least one flexible strand extends across said open space terminating a first end of said flexible strand at a first hole on said first side and terminating a second end of said flexible strand at a first hole on said second side.

4. The writing tool of claim 1, wherein said frame includes one of the following: plastic, wood, and metal.

5. The writing tool of claim 1, wherein said frame is transparent.

6. The writing tool of claim 1, wherein said frame is opaque.

7. The writing tool of claim 1, wherein said from is colored.

8. The writing tool of claim 1, wherein said frame is substantially rectangular.

9. The writing tool of claim 1, wherein said frame is substantially square.

10. The writing tool of claim 1, wherein said frame includes an embedded design.

11. The writing tool of claim 1, wherein said frame includes measuring indicia on at least one of said first and said second sides.

12. The writing tool of claim 1, wherein said frame includes measuring indicia on said at least one rigid member.

13. A writing tool comprising:
a rigid frame having a first side and an opposing second side and at least one rigid member therebetween, wherein said first side and said opposing side are spaced apart so as to define an open space therebetween;
a plurality of holes in each of said first and second sides, said holes in each of said first and second sides are connected by a recessed channel; and
at least one flexible strand secured to said first and said second side through said plurality of holes in each of said first and second sides;
wherein said at least one flexible strand is configured as a guideline that extends across said open space.

14. The writing tool of claim 13, wherein said at least one flexible strand is thread through said plurality of holes in each of said first and second sides.

15. The writing tool of claim 14, wherein at least a portion of said at least one flexible strand is disposed within said recessed channel.

16. The writing tool of claim 13, wherein said at least one flexible strand extends across said open space terminating a first end of said flexible strand at a first hole on said first side and terminating a second end of said flexible strand at a first hole on said second side.

17. The writing tool of claim 13, wherein said frame includes one of the following: plastic, wood, and metal.

18. The writing tool of claim 13, wherein said frame is transparent.

19. The writing tool of claim 13, wherein said frame is opaque.

20. The writing tool of claim 13, wherein said from is colored.

21. The writing tool of claim 13, wherein said frame is substantially rectangular.

22. The writing tool of claim 13, wherein said frame is substantially square.

23. The writing tool of claim 13, wherein said frame includes an embedded design.

24. The writing tool of claim 13, wherein said frame includes measuring indicia on at least one of said first and said second sides.

25. The writing tool of claim 13, wherein said frame includes measuring indicia on said at least one rigid member.
